(19) United States
(12) Patent Application Publication
(10) Pub. No.: US 2018/0219398 A1
(43) Pub. Date: Aug. 2, 2018

(54) CLEANING DEVICE AND METHOD FOR OPERATING A CLEANING DEVICE

(71) Applicant: Alfred Kärcher GmbH & Co. KG, Winnenden (DE)

(72) Inventors: Michael Schuetz, Stuttgart (DE); Timo Guttenkunst, Stuttgart (DE); Gerhard Vorholzer, Fichtenberg (DE); Attila Orban, Backnang (DE)

(21) Appl. No.: 15/940,216

(22) Filed: Mar. 29, 2018

Related U.S. Application Data
(63) Continuation of application No. PCT/EP2015/072614, filed on Sep. 30, 2015.

(51) Int. Cl. H02J 7/00; A47L 11/40

(52) U.S. Cl. CPC H02J 7/0063; H02J 7/0013; H02J 2007/0067; A47L 11/4002; H02J 7/0047

(57) ABSTRACT

A cleaning device is provided, including an electrical consumption unit, at least two batteries, a discharge circuit electrically connecting these to the consumption unit, and a control unit for controlling the discharge circuit, wherein the batteries are connected to each other in parallel. To increase the utility and operational safety of the cleaning device, in the discharge operation of the cleaning device, a parameter reflecting a respective state of charge of the batteries is determinable, and the discharge circuit is controllable by the control unit such that, depending on the result of the determination, a respective discharge current path for the respective battery, in which discharge current path the consumption unit is arranged, is optionally releasable or blockable by means of at least one electrical switching element. In addition, methods for operating a cleaning device are provided.

### CROSS-REFERENCE TO RELATED APPLICATIONS

This application is a continuation of International Patent Application Number PCT/EP2015/072614, filed Sep. 30, 2015, which is incorporated herein by reference in its entirety and for all purposes.

### FIELD OF THE INVENTION

The present invention relates to a cleaning device comprising an electrical consumption unit, at least two batteries, a discharge circuit electrically connecting these to the consumption unit, and a control unit for controlling the discharge circuit, wherein the batteries are connected to each other in parallel.

Further, the present invention relates to a method for operating a cleaning device.

### BACKGROUND OF THE INVENTION

The operation of a cleaning device by means of batteries offers the advantage that the user is independent of the connection of the cleaning device to an energy supply network and the radius of action of the cleaning device is thereby enlarged. It is thereby desirable for the duration of use of the cleaning device to be as long as possible in or order to execute cleaning tasks as quickly as possible and with a smallest possible number of interruptions for changing or charging the batteries. A possible outage of the cleaning device should be avoided. An outage of that kind may result from, for example, the fact that batteries of different types are used and/or that batteries have different states of charge and aging. Batteries may be used that have an internal intrinsic safety that is supposed to prevent discharge currents (and/or charging currents) that are too high as well as an excessive temperature of the batteries possibly connected therewith. Hereby, there is the risk, however, that, upon intervention of the intrinsic safety, a battery still having in itself a high charge is internally switched off for the sake of safety, which would lead to an outage of the cleaning device. It also proves to be problematic that, especially in the case of batteries of different type, state of charge and/or aging, compensating currents may flow between the batteries. The power providable to the consumption unit is thereby reduced and the operation of the cleaning device is impaired.

Presently, all kinds of electrical energy stores, from which an electrical charge may be provided to the consumption unit in the discharge operation, are considered batteries. In particular, the batteries are rechargeable, i.e. accumulators. Hereby, Li-ion or lead batteries may be used for example. The batteries may have an internal intrinsic safety that may become active upon discharging and/or upon charging the battery.

An object of the present invention is to provide a generic cleaning device and a method for operating a cleaning device, in which or with which the utility of the cleaning device for a user is increased and the operational safety of the cleaning device is increased where possible.

### SUMMARY OF THE INVENTION

In a first aspect of the invention, a cleaning device comprises an electrical consumption unit, at least two batteries, a discharge circuit electrically connecting these to the consumption unit, and a control unit for controlling the discharge circuit, wherein the batteries are connected to each other in parallel. In the discharge operation of the cleaning device, a parameter reflecting a respective state of charge of the batteries is determinable. The discharge circuit is controllable by the control unit such that, depending on the result of the determination, a respective discharge current path for the respective battery, in which discharge current path the consumption unit is arranged, is optionally releasable or blockable by means of at least one electrical switching element.

In a second aspect of the invention, in the discharge operation of a cleaning device in accordance with the first aspect, a parameter reflecting a respective state of charge of the batteries is determined, and the discharge circuit may be controlled by the control unit such that, depending on the result of the determination, a respective discharge current path for the respective battery, in which discharge current path the consumption unit is arranged, is optionally released or blocked by means of at least one electrical switching element.

### BRIEF DESCRIPTION OF THE DRAWINGS

The foregoing summary and the following description may be better understood in conjunction with the drawing figures, of which:

FIG. 1 shows schematically a cleaning device in accordance with the invention for carrying out the method in accordance with the invention, wherein a circuit comprised by the cleaning device is partially depicted; and

FIG. 2 shows an advantageous embodiment of the cleaning device for carrying out the method, wherein the cleaning device is configured as a scrubbing machine.

### DETAILED DESCRIPTION OF PREFERRED EMBODIMENTS OF THE INVENTION

Although the invention is illustrated and described herein with reference to specific embodiments, the invention is not intended to be limited to the details shown. Rather, various modifications may be made in the details within the scope and range of equivalents of the claims and without departing from the invention.

The present invention relates to a cleaning device comprising an electrical consumption unit, at least two batteries, a discharge circuit electrically connecting these to the consumption unit, and a control unit for controlling the discharge circuit, wherein the batteries are connected to each other in parallel. In the discharge operation of the cleaning device, a parameter reflecting a respective state of charge of the batteries is determinable. The discharge circuit is controllable by the control unit such that, depending on the result of the determination, a respective discharge current path for the respective battery, in which discharge current path the consumption unit is arranged, is optionally releasable or blockable by means of at least one electrical switching element.

In the cleaning device in accordance with the invention, provision is made for the discharge circuit, in particular the respective at least one switching element in the respective discharge current path, to be able to be selectively controlled by the control unit in the discharge operation of the cleaning device. By means of the determination of the value of the parameter, it may be determined what the state of charge of the respective battery is. This reflects the value of the parameter linked to the battery and is also designated as a parameter of the battery. Depending on the value of the parameter, the control unit may decide whether a respective battery may be connected or disconnected, i.e. the respective discharge current path may be optionally released or blocked. In particular, this offers the advantage that the releasing and/or blocking of discharge current paths may occur by means of a discharge circuit arranged externally to the batteries. The danger mentioned hereinabove that, for example, different battery types, states of charge and/or aging of the batteries effect an automatic disconnect of the batteries by means of an internal intrinsic safety may hereby be prevented. The provision of the external, controllable discharge circuit therefore allows for the cleaning device to be operated independently of the type of battery, of the state of charge and/or aging and therefore independently of the background of the batteries. This advantageously allows for batteries of different types to be used, for example also from different manufacturers. The exchange of batteries is simplified, favorably not all batteries are to be replaced in each case, in order to maintain the safe operation of the cleaning device. Possible efforts for the certification of batteries for use in the cleaning device may be forgone. The handling of the cleaning device and the operational safety thereof are increased for the operator.

It is understood that the releasing and/or the blocking depending on the value of the parameter, also comprises that an existing releasing and an existing blocking, respectively, of the corresponding discharge current path is maintained.

It is favorable if the parameter is periodically determinable. For example, the determination of the parameter occurs in the rhythm of a few milliseconds or seconds.

In practice, it proves to be advantageous if a discharge current of the respective battery in the discharge current path is determinable as a parameter.

Alternatively or in addition, provision may be made for a terminal voltage of the respective battery to be determinable as a parameter.

It is advantageous if a respective discharge current path is releasable if the value of the parameter of the corresponding battery exceeds a minimum value. The minimum value may be predetermined or predeterminable. The releasing above the minimum value is in particular advantageous if the batteries have significantly different states of charge. In this case, for example, a battery may first be discharged by releasing the corresponding discharge current path, whereas the second battery is not discharged by blocking the other discharge current path. If both batteries have approximately the same state of charge after discharging the first-mentioned battery, then the discharge current path firstly blocked may be released and both batteries may be operated in parallel.

Provision may be made for the discharge current path to be blockable if the value of the parameter exceeds the minimum value.

It is favorable if the consumption unit is controllable by the control unit to assume a high power operation or to assume a low power operation in which the power consumption of the consumption unit is less than in the high power operation. In particular, the current, drawn by the consumption unit, that must be provided via the discharge current paths is greater in the high power operation than in the low power operation. By controlling the consumption unit, it is possible, if necessary, to switch from the high power operation into the low power operation or vice versa, depending on the result of the determination of the respective value of the parameters. It may thereby be ensured that the batteries are not overloaded in the high power operation, which could lead to an internal disconnection of the batteries. The operational safety of the cleaning device is thereby increased. Inversely, the high power operation may be assumed in order to increase the cleaning effect of the cleaning device.

For example, the consumption unit is controllable to assume the high power operation upon putting the cleaning device into operation.

The consumption unit is preferably controllable to assume the low power operation if at least one of the following conditions is fulfilled:
the values of the parameters deviate from each other by a minimum difference;
the value of the parameter of at least one battery exceeds a maximum value.

In both aforementioned cases, it may be ensured, for example, that by assuming the low power operation, a discharge current so high that it may result in a disconnection of the battery by means of the internal intrinsic safety does not flow in one of the discharge current paths. Provision may be made for both aforementioned conditions to have to be cumulatively fulfilled in order to enable an assumption of the low power operation.

It proves to be advantageous if the consumption unit, starting from the low power operation, is controllable to assume the high power operation if the values of the parameters of the batteries deviate from each other by a difference that is maximally as great as the minimum difference. The utility for the user is thereby increased by enhancing the cleaning performance.

Favorably, the cleaning device has an indication unit by means of which the assumption of the low power operation and/or the high power operation is able to be signaled to a user. The indication unit, which is preferably controllable by the control unit, may in particular be configured optically or acoustically and may comprise an image display (display) or lighting elements displaying the respective operation.

The at least one switching element of each discharge current path comprises, for example, a transistor that is switchable into a release state for releasing the respective discharge current path and into a block state for blocking the respective discharge current path. MOSFETs, for example, are used as transistors.

The transistor may comprise an internal body diode. Upon assuming the discharge operation, the transistor may assume a block state and the respective discharge current path may be blocked. A discharge current may nonetheless first flow via the internal body diode, by means of which discharge current the value of the discharge current is determined as a parameter. If said value is above the aforementioned minimum value, then the transistor may be switched into the release state and the discharge current path may be released.

In an advantageous implementation of the cleaning device, two transistors are arranged in the respective discharge current path, wherein each one transistor, in the discharge operation of the cleaning device, permanently assumes a release state. The transistors are connected in series, however preferably with opposite polarity to each other. A discharge circuit of that kind proves to be advantageous, for example, if the subsequently described charging circuit is additionally used in the cleaning device.

It is favorable if the batteries are rechargeable batteries and if the cleaning device has a charging unit which is electrically connected to the batteries via a charging circuit. The batteries may thereby be charged in the cleaning device. A removal of the batteries is not necessary. The charging circuit is preferably controllable by the control unit.

It is advantageous if, in the charging operation, a parameter reflecting the respective state of charge of the batteries is determinable and if the charging circuit is controllable by the control unit such that, depending on the result of the determination, a respective charging current path for the respective battery is optionally releasable or blockable by means of at least one electrical switching element. Correspondingly to discharging, a respective charging current path may thereby selectively be opened or closed based on the result of the determination in the charging operation. Excessively high charging currents that may lead to a disconnection of batteries with internal intrinsic safety may thereby be avoided.

Favorably, the discharge circuit and the charging circuit are at least partially identical. Components like, for example, electrical switching elements may be used in the discharge circuit as well as in the charging circuit.

Advantageously, the parameter in the charging operation is periodically determinable, for example in the rhythm of milliseconds or seconds.

In the charging operation, in particular a charging current of the respective battery in the charging current path may be determined as a parameter.

Alternatively or in addition, provision may be made for a terminal voltage of the respective battery to be determined.

If batteries with internal intrinsic safety are used, provision may be made for it to be gathered by a safety circuit whether the respective battery is granting a charging release. In the case of a lacking or cancelled charging release, the respective charging current path is preferably permanently blocked by means of the at least one switching element in order to avoid a disruption to the cleaning device.

A respective charging current path is preferably releasable if the value of the parameter in the charging operation exceeds a minimum value.

It is favorable if the charging unit is controllable by the control unit to assume a high power charging mode and to assume a low power charging mode in which a charging current providable by the charging unit is less than in the high power charging mode. This allows, for example, avoiding that a battery, upon assuming the high power charging mode, is supplied with an excessively high charging current that could lead to a disconnection of the batteries due to an internal intrinsic safety. Instead, depending on the value of the corresponding parameter in the charging operation, the low power charging mode may be assumed in order to avoid an excessively high charging current.

The charging unit is, for example, controllable to assume the low power charging mode upon beginning the charging operation.

It is favorable if the charging unit is controllable to assume the high power charging mode if at least one of the following conditions is fulfilled:
the values of the parameters deviate from each other by less than a maximum difference;
the value of the parameter of at least one battery in the charging operation is under a threshold value.

If the deviation of the states of charge of the batteries is relatively small, such that the values of the parameters differ from each other by less than the maximum difference, then the high power charging mode may be assumed for accelerated charging. For the sake of safety, it may be assessed whether the value of the parameter of at least one battery is under a threshold value in order to avoid an excessive charging current. Provision may be made for the aforementioned conditions to have to be cumulatively fulfilled in order to enable the assumption of the high power mode.

The charging unit is preferably controllable, starting from the high power charging mode, to assume the low power charging mode if the value of the parameter in the charging operation of at least one battery is greater than the threshold value. An excessive charging current for a battery may be avoided by assuming the low power charging mode. Provision may be made for a switching into the low power charging mode to not occur until the value of the parameter exceeds a maximum value that is greater than the threshold value.

Favorably, the cleaning device has an indication unit by means of which the assumption of the low power charging mode and/or the high power charging mode is able to be signaled to a user. The indication unit may in particular be the indication unit already previously mentioned.

At least one switching element of each charging current path comprises, for example, a transistor that is switchable into a release state for releasing the respective charging current path and into a block state for blocking the respective charging current path. The transistors may be controlled by the control unit. The transistors are MOSFETs, for example.

The transistor may comprise an internal body diode. Provision may be made for the transistor to first assume a block state for blocking the charging current path upon beginning the charging operation. A charging current may nonetheless flow through the body diode, the charging current being assessed as a parameter with regard to its value. Depending on the value of the charging current, the transistor may be switched into the release state for releasing the charging current path.

Provision may be made for two transistors to be arranged in the respective charging current path, wherein each one transistor in the charging operation of the cleaning device permanently assumes a release state. This is advantageous, for example, if the discharge circuit and the charging circuit are at least partially identical. The transistors are connected in series in the respective charging current path, wherein they may be arranged in particular in opposing polarity. In an advantageous embodiment, the transistor permanently assuming the release state is the electrical switching element of the discharge circuit that in the discharge operation is switchable, depending on the parameter.

The consumption unit comprises or is preferably at least one drive motor for a suction unit or a cleaning tool. Correspondingly, the cleaning device may in particular be a suction device.

An advantageous cleaning device is a floor cleaning device, in particular a scrubbing machine or a sweeping machine.

As mentioned hereinabove, the present invention also relates to a method.

The object mentioned hereinabove is achieved by a method in accordance with the invention for operating a cleaning device of the kind previously mentioned, wherein, in the discharge operation of the cleaning device, a parameter reflecting a respective state of charge of the batteries is determined, and the discharge circuit may be controlled by the control unit such that, depending on the result of the determination, a respective discharge current path for the respective battery, in which discharge current path the consumption unit is arranged, is optionally released or blocked by means of at least one electrical switching element.

The advantages that have already been mentioned, which are achievable by using the cleaning device in accordance with the invention, may likewise be achieved by carrying out the method. In regard to this, in order to avoid repetition, reference may be made to the preceding descriptions.

Advantageous embodiments of the method in accordance with the invention arise through advantageous embodiments of the cleaning device in accordance with the invention, such that reference may also be made to the preceding explanations in this regard.

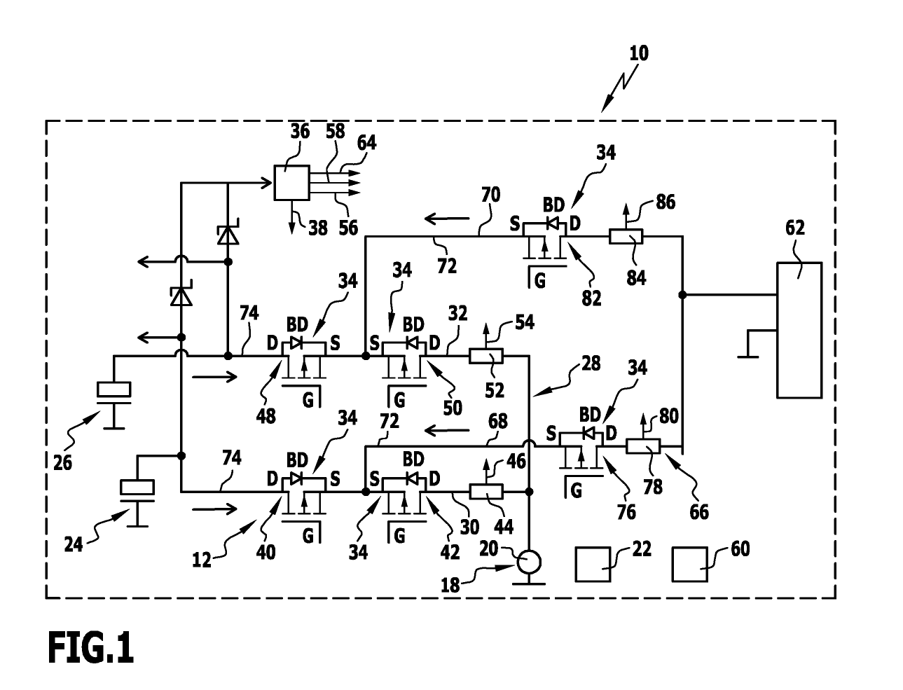

FIG. 1 shows an advantageous embodiment of the cleaning device in accordance with the invention that has been attributed with the reference numeral 10. The cleaning device 10 is depicted only schematically by means of a dashed line, and FIG. 1 shows a circuit 12 comprised by the cleaning device 10, where necessary for understanding the present invention. The cleaning device 10 depicted for example in FIG. 1 is, for example, a suction device such as a vacuum cleaner, a scrubbing machine, or a sweeping machine.

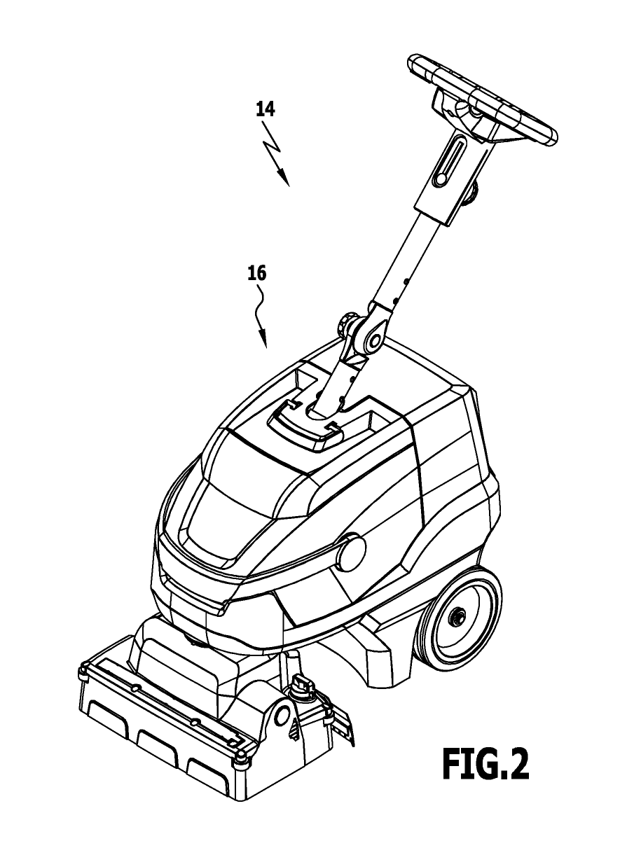

FIG. 2 shows for example an advantageous embodiment of a cleaning device in accordance with the invention that has been attributed with the reference numeral 14. The cleaning device 14 is configured as a scrubbing machine 16 in accordance with the invention. The subsequent descriptions made with reference to FIG. 1 also apply to the scrubbing machine 16 depicted in FIG. 2, which has the components depicted in FIG. 1.

The cleaning device 10 in accordance with the invention comprises an electrically supplied consumption unit 18. The consumption unit 18 is configured as a drive motor 20 for a suction unit 22 or a cleaning tool of the cleaning device 10.

For the purpose of providing electrical energy for the drive motor 20, the cleaning device 10 comprises two or more batteries. Presently, two batteries 24, 26 are depicted in FIG. 1. The batteries 24, 26 are connected in parallel to each other by the circuit 12.

The circuit 12 comprises a discharge circuit 28 that has two discharge current paths 30, 32. The battery 24 is connected to the drive motor 20 via the discharge current path 30. The battery 26 is connected to the drive motor 20 via the discharge current path 32.

At least one controllable electrical switching element, with which the respective discharge current path 30, 32 may be optionally released or blocked, is arranged in each discharge current path 30, 32. The respective switching element may thereby assume a release state or a block state, respectively.

Presently, provision is made for two switching elements to be arranged in series in each discharge current path 30, 32. The switching elements are each designated in the drawing with the reference numeral 34.

In the cleaning device 10, the switching elements 34 are configured as transistors, in particular MOSFETs, specifically p-channel self-locking MOSFETs. The MOSFETs have a respective internal body diode. In the drawing, the letters D Drain, S Source, G Gate, and BD designate the respective internal body diode of a transistor. The respective polarity reversal of the transistors thereby arises within the circuit 12.

A respective switching element 34 of the discharge circuit 28 is controllable by a control unit 36 of the cleaning device 10. To this end, the control unit 36 may switch the respective Gate G of a transistor either conductively to assume the release state, or in a blocking manner to assume the block state. A control line 38 symbolizes the coupling of the control unit 36 to the gate terminals.

Arranged in the discharge current path 30 is a transistor 40 and following this in series is a transistor 42. The transistors 40, 42 are arranged oppositely polarized to each other. For example, following the transistor 42, a measuring element 44 is arranged in the discharge current path 30. A parameter linked to the state of charge of the battery 24 may be determined by means of the measuring element 44. A signal regarding this may be provided to the control unit 36 via a signal line 46.

The parameter is presently a discharge current that flows from the battery 24, through the discharge current path 30, to the drive motor 20.

The same applies to the discharge current path 32 in which a transistor 48 and a transistor 50 following this in series is arranged. The transistors 48 and 50 are arranged oppositely polarized to each other. For example, a measuring element 52 is arranged following the transistor 50 in the discharge current path 32. A parameter linked to the state of charge of the battery 26 may be determined with the measuring element 52 and a signal regarding this may be provided to the control unit 36 via a signal line 54.

A discharge current that flows from the battery 26, through the discharge current path 32, to the drive motor 20 is presently used as a parameter.

The control unit 36 is coupled to the drive motor 20 via a control line 56. The drive motor 20 is thereby controllable by the control unit 36. In particular, the drive motor 20 may assume a high power operation and a low power operation, depending on the signal from the control unit 36. In the low power operation, the power consumption of the drive motor 20 is less than in the high power operation, wherein the drive motor 20 draws a reduced current. In the high power operation, the drive motor 20, and thereby the suction unit 22, are being operated with high power. The cleaning performance of the cleaning device 10 is thereby increased.

In an implementation of the cleaning device 10 in practice, the drive motor 20 in the high power operation draws, for example, about 25 A of current, in the low power operation about 15 A, for example.

The control unit 36 is coupled to an indication unit 60 via a control line 58. The indication unit 60 is, for example, an optical indication unit. The indication unit 60 may comprise an image display, for example a display and/or lighting elements.

The cleaning device 10 further comprises a charging unit 62 for charging the batteries 24, 26. The charging unit 62 is coupled to the control unit 36 via the control line 64. The charging unit 62 is in particular controllable by the control unit 36 to assume a low power charging mode or a high power charging mode. In the low power charging mode, a lower charging current is provided than in the high power charging mode.

In practice, charging currents of, for example, about 20 A in the high power charging mode and about 10 A in the low power charging mode are provided at charging voltage of about 24 V.

The cleaning device 10 has a charging circuit 66 as a constituent of the circuit 12. The batteries 24, 26 are connected to the charging unit 62 in parallel via the charging circuit 66. A first charging current path 68 connects the charging unit 62 to the battery 24. A second charging current path 70 connects the charging unit 62 to the battery 26.

The discharge circuit 28 and the charging circuit 66 are presently favorably partially identical. The charging current paths 68, 70 have a respective first section 72 and a respective second section 74. The first section 72 connects the charging unit 62 to the respective discharge current path 30 or 32 between the transistors 40 and 42, and between the transistors 48 and 50, respectively. The second section 74 connects to the first section 72 and extends up to the respective battery 24 and 26, respectively.

At least one switching element 34 of the discharge circuit 66, which switching element 34 is controllable by the control unit 36, is also arranged in the respective charging current paths 68 and 70. The respective discharge current path 68 or 70 may thereby be optionally released or blocked.

A transistor 76 and the transistor 40 post-connected in series thereto is arranged in the charging current path 68 as a switching element 34. The transistors 76 and 40 are arranged oppositely polarized to each other. For example, a measuring element 78 is arranged in the charging current path 68 upstream from the transistor 76. A parameter linked to the state of charge of the battery 34 may be determined by the measuring element 78, and a signal regarding this may be provided to the control unit 36 via a control line 80.

The parameter is presently a charging current that flows from the charging unit 62, through the charging current path 68, to the battery 24.

In a corresponding manner, a switching element 34, configured as transistor 82, is arranged in the charging current path 70. Arranged downstream from the transistor 82 in the charging current path 70 is the transistor 48, wherein the transistors 48 and 82 are arranged oppositely polarized to each other. Further, a measuring element 84 is arranged in the charging current path 70, for example upstream from the transistor 82. A parameter linked to the state of charge of the battery 26 may be determined with the measuring element 84, and a signal regarding this may be provided to the control unit 36 via a signal line 86.

The parameter is presently a charging current that flows from the charging unit 62, through the charging current path 70, to the battery 26.

The control unit 36 may, depending on the result of the determination of the respective parameter in the discharge operation and in the charging operation of the cleaning device 10, switch the transistors 40, 42, 48, 50, 76, and 82 into the respective release or block state for selectively releasing or blocking the discharge current paths 30, 32 or the charging current paths 68, 70.

Discharge currents and charging currents may be measured quasi-continuously periodically, for example at an interval of milliseconds or seconds.

The functioning of the cleaning device 10 will subsequently be described, wherein first a discharge operation of the batteries 24, 26 will be discussed as it exists in the work operation of the cleaning device 10.

Upon beginning the discharge operation of the cleaning device 10, i.e. its being put into operation, provision may be made for the control unit 36 to control the drive motor 20 to assume the high power operation.

In the discharge operation, the transistor 40 is first in the block state and the transistor 42 in the release state. In a corresponding manner, first the transistor 48 is in the block state and the transistor 50 in the release state. The transistors 42 and 50 permanently remain in the release state in the discharge operation.

The transistors 76 and 82 are in the block state. The blocking of the transistors 76 and 82 has in particular the advantage that possible compensating currents between the batteries 24 and 26, if the transistors 40, 48 are released, may be avoided by means of the transistors 76 and 82.

First, the respective discharge current in the discharge current paths 30, 32 is determined by the measuring elements 44, 52. This is possible in that the transistors 42 and 50 are released and a current flow via the internal body diodes BD, which are operated in the forward direction, is possible.

The value of the parameter, i.e. the respective discharge current may be evaluated. Depending on the respective discharge current, the control unit 36 controls the transistors 40 and 48 to release the discharge current paths 30, 32.

In particular, the respective transistor 40, 48 is only released if a corresponding discharge current is determined that is above a minimum value. In a corresponding manner, provision is made for the respective transistor 40, 48 to be blocked if the corresponding discharge current falls below the minimum value.

In an implementation of the cleaning device 10 in practice, the output voltage of the batteries 24, 26 may be 24 V, for example. The minimum value for the respective discharge current is about 1 A, for example.

The drive motor 20 is supplied with energy via each released discharge current path 30, 32. If both transistors 40, 48 are released, the drive motor 20 may be supplied with energy concurrently from the batteries 24, 26. In the high power operation, the full power of the drive motor 20 may be utilized for a high cleaning effect.

However, the discharge currents are assessed to the effect of whether they exceed a maximum value. If a respective discharge current is greater than a maximum value, for example about 25 A, then the control unit 36 controls the drive motor 20 to assume the low power operation.

The same applies if the discharge currents in the discharge current paths 30, 32 differ from each other by a minimum difference, for example by about 20 A.

In both cases, the assumption of the low power operation serves to avoid that such a high discharge current flows via the corresponding discharge current path 30 or 32, that it could lead to a disconnection of the batteries 24 or 26 due to internal intrinsic safety. An undesired outage of the cleaning device 10 is thereby prevented.

Starting from the low power operation, the control unit 36 may trigger the drive motor 20 to assume the high power operation. This is the case in particular if the discharge currents deviate from each other only by a difference that is maximally as great as the aforementioned minimum difference. In an implementation of the cleaning device 10, this difference, at which the high power operation is switched into again, is about 5 A, for example.

The assumption of the low power operation or the high power operation may be displayed on the indication unit 60 to an operator.

In the cleaning device 10, an advantage lies in particular in the fact that the operational safety of the cleaning device 10 and its user friendliness are increased by the discharge circuit 28 provided externally to the batteries 24, 26.

Independently of the type and the background, in particular the state of charge and/or aging, of the respective battery, different batteries 24, 26 may be used. In particular, a use of batteries of mixed types is possible (for example Li-ion or lead accumulators) and/or the use of batteries with or without internal intrinsic safety.

By selectively releasing or blocking the discharge current paths 30 and 32, as well as selectively switching between the low power operation and the high power operation, it may be effectively prevented that discharge currents result in a disconnection of the batteries 24, 26 due to internal intrinsic safety, if one of such kind is present. In the case of the presence of batteries 24, 26 with states of charge differing significantly from each other, the more strongly charged battery 24, 26 is discharged first by the corresponding discharge current path 30, 32 being released and the respective other discharge current path 30, 32 being blocked. In the case of progressive matching of the states of charge, both batteries 24, 26 may be discharged and the drive motor 20 may be supplied concurrently.

In the subsequently described charging operation of the cleaning device 10, provision may be made for the control unit 26 to initially control the charging unit 62 to assume the low power charging mode.

In the discharge operation, the transistor 76 first assumes a block state in the discharge current 68, and the transistor 40 a release state. In a corresponding manner, the transistor 82 assumes a block state in the discharge current path 70, and the transistor 48 a release state. The transistors 40, 48 remain in the release state during the charging operation.

The transistors 42, 50 remain in the block state during the charging operation. It is thereby prevented that possible compensation currents between the batteries 24, 26 may flow through the transistors 42, 50 during the charging operation, and the at least one cleaning tool or cleaning unit remains blocked in the charging operation.

Upon beginning the charging operation, a respective charging current may flow via the internal body diodes DB of the transistors 76, 82, which body diodes are operated in the forward direction. By means of the measuring elements 78, 84, the charging current may be determined as a parameter about the state of charge of the batteries 24, 26. Depending on the value of the charging current, the control unit 36 may selectively release and block the transistors 76, 82.

In particular, a respective charging current path 68, 70 is only released if the corresponding charging current exceeds a minimum value. In a corresponding manner, provision is made for the respective charging current path 68, 70 to be blocked if the charging current exceeds the minimum value.

In an implementation of the cleaning device 10, the minimum value is about 1 A, for example, above which the transistors 76, 82 are released.

That battery 24, 26, whose associated transistor 76 or 82, respectively, is released, is charged first and with greater current, respectively. Upon releasing both transistors 76, 82, both batteries 24, 26 may be charged in parallel with equal charging current.

The control unit 36 may control the charging unit 62 to assume the high power charging mode if the charging currents deviate from each other by less than a maximum difference (for example about 3 A). In addition, it may be assessed whether a respective charging current is below a threshold value, for example about 8 A.

The assumption of the high power charging mode allows for a quick charging of both batteries 24, 26. By meeting at least one of the abovementioned conditions, it is ensured that the respective charging current in the charging current path 68 or 70 does not get so large that it could lead to a disconnection of a battery 24, 26 due to an internal intrinsic safety.

To this end, provision may advantageously be made for the charging currents to be assessed upon exceeding the threshold value. In the mentioned example of the threshold value of 8 A, the low power charging mode is only reassumed, for example, if at least one charging current is greater than about 15 A.

The assumption of the low power charging mode or the high power charging mode may be symbolized on the indication unit 60 to the user.

The advantages already mentioned in conjunction with the description of the discharge operation may also be achieved in the charging operation by providing the charging circuit 66 arranged externally to the batteries 24, 26. In order to avoid repetition, reference may be made to the preceding descriptions.

It is understood that the values presently listed exemplarily for the discharge currents and the charging currents, as well as the battery voltages or the voltage of the charging unit 62 are nonrestrictive. The person skilled in the art will be able to modify these values according to the requirements of the cleaning device 10 for carrying out the invention.

### REFERENCE NUMERAL LIST

10 cleaning device
12 circuit
14 cleaning device
16 scrubbing machine
18 consumption unit
20 drive motor
22 suction unit
24 battery
26 battery
28 discharge circuit
30 discharge current path
32 discharge current path
34 switching element
36 control unit
38 control line
40 transistor
42 transistor
44 measuring element
46 signal line
48 transistor
50 transistor
52 measuring element
54 signal line
56 control line
58 control line
60 indication unit
62 charging unit
64 control line
66 charging circuit
68 charging current path
70 charging current path
72 first section
74 second section
76 transistor
78 measuring element
80 signal line
82 transistor
84 measuring element
86 signal line

1. A cleaning device comprising an electrical consumption unit, at least two batteries, a discharge circuit electrically connecting these to the consumption unit, and a control unit for controlling the discharge circuit, wherein the batteries are connected to each other in parallel, wherein in the discharge operation of the cleaning device, a parameter reflecting a respective state of charge of the batteries is determinable, and wherein the discharge circuit is controllable by the control unit such that, depending on the result of the determination, a respective discharge current path for the respective battery, in which discharge current path the consumption unit is arranged, is optionally releasable or blockable by means of at least one electrical switching element.

2. The cleaning device in accordance with claim 1, wherein the parameter is periodically determinable.

3. The cleaning device in accordance with claim 1, wherein at least one of a discharge current of the respective battery in the discharge current path and a terminal voltage of the respective battery is determinable as a parameter.

4. The cleaning device in accordance with claim 1, wherein a respective discharge current path is releasable if the value of the parameter exceeds a minimum value.

5. The cleaning device in accordance with claim 4, wherein the discharge current path is blockable if the value of the parameter falls below the minimum value.

6. The cleaning device in accordance with claim 1, wherein the consumption unit is controllable by the control unit to assume a high power operation or to assume a low power operation in which the power consumption of the consumption unit is less than in the high power operation.

7. The cleaning device in accordance with claim 6, wherein the consumption unit is controllable to assume the high power operation upon putting the cleaning device into operation.

8. The cleaning device in accordance with claim 6, wherein the consumption unit is controllable to assume the low power operation if at least one of the following conditions is fulfilled:
the values of the parameters deviate from each other by a minimum difference;
the value of the parameter of at least one battery exceeds a maximum value.

9. The cleaning device in accordance with claim 8, wherein the consumption unit, starting from the low power operation, is controllable to assume the high power operation if the values of the parameters of the batteries deviate from each other by a difference that is maximally as great as the minimum difference.

10. The cleaning device in accordance with claim 6, wherein the cleaning device has an indication unit by means of which the assumption of at least one of the low power operation and the high power operation is able to be signaled to a user.

11. The cleaning device in accordance with claim 1, wherein at least one switching element of each discharge current path comprises a transistor that is switchable into a release state for releasing the respective discharge current path and into a block state for blocking the respective discharge current path.

12. The cleaning device in accordance with claim 11, wherein the transistor comprises an internal body diode.

13. The cleaning device in accordance with claim 11, wherein two transistors are arranged in the respective discharge current path, wherein each one transistor, in the discharge operation of the cleaning device, permanently assumes a release state.

14. The cleaning device in accordance with claim 1, wherein the batteries are rechargeable batteries, and wherein the cleaning device has a charging unit which is electrically connected to the batteries via a charging circuit.

15. The cleaning device in accordance with claim 14, wherein the discharge circuit and the charging circuit are at least partially identical.

16. The cleaning device in accordance with claim 14, wherein in the charging operation, a parameter reflecting a respective state of charge of the batteries is determinable, and wherein the charging circuit is controllable by the control unit such that, depending on the result of the determination, a respective charging current path for the respective battery is optionally releasable or blockable by means of at least one electrical switching element.

17. The cleaning device in accordance with claim 16, wherein the parameter is periodically determinable.

18. The cleaning device in accordance with claim 16, wherein at least one of a charging current of the respective battery in the charging current path and a terminal voltage of the respective battery is determinable as a parameter.

19. The cleaning device in accordance with claim 16, wherein a respective charging current path is releasable if the value of the parameter exceeds a minimum value.

20. The cleaning device in accordance with claim 16, wherein the charging unit is controllable by the control unit to assume a high power charging mode and to assume a low power charging mode in which a charging current providable by the charging unit is less that in the high power charging mode.

21. The cleaning device in accordance with claim 20, wherein the charging unit is controllable to assume the low power charging mode upon beginning the charging operation.

22. The cleaning device in accordance with claim 20, wherein the charging unit is controllable to assume the high power charging mode if at least one of the following conditions is fulfilled:
the values of the parameters deviate from each other by less than a maximum difference;
the value of the parameter of at least one battery is under a threshold value.

23. The cleaning device in accordance with claim 22, wherein the charging unit, starting from the high power charging mode, is controllable to assume the low power charging mode if the value of the parameter of at least one battery is greater than the threshold value.

24. The cleaning device in accordance with claim 20, wherein the cleaning device has an indication unit by means of which the assumption of at least one of the low power charging mode and the high power charging mode is able to be signaled to a user.

25. The cleaning device in accordance with claim 15, wherein at least one switching element of each charging current path comprises a transistor that is switchable into a release state for releasing the respective charging current path and into a block state for blocking the respective charging current path.

26. The cleaning device in accordance with claim 25, wherein the transistor comprises an internal body diode.

27. The cleaning device in accordance with claim 25, wherein two transistors are arranged in the respective charging current path, wherein each one transistor in the charging operation of the cleaning device permanently assumes a release state.

28. The cleaning device in accordance with claim 1, wherein the consumption unit is or comprises at least one drive motor for a suction unit or a cleaning tool.

29. The cleaning device in accordance with claim 1, wherein the cleaning device is a floor cleaning device.

30. The cleaning device in accordance with claim 29, wherein the cleaning device is a scrubbing machine or a sweeping machine.

31. A method for operating a cleaning device, the cleaning device comprising an electrical consumption unit, at least two batteries, a discharge circuit electrically connecting these to the consumption unit, and a control unit for controlling the discharge circuit, wherein the batteries are connected to each other in parallel, wherein, in the discharge operation of the cleaning device, a parameter reflecting a respective state of charge of the batteries is determined, and the discharge circuit is controlled by the control unit such that, depending on the result of the determination, a respective discharge current path for the respective battery, in which discharge current path the consumption unit is arranged, is optionally released or blocked by means of at least one electrical switching element.
